(19) United States
(12) Patent Application Publication
(10) Pub. No.: US 2008/0055380 A1
(43) Pub. Date: Mar. 6, 2008

(54) Radio frequency drying of ink on an intermediate member

(76) Inventors: Michael T. Regan, Fairport, NY (US); David D. Putnam, Fairport, NY (US); Mary Christine Brick, Webster, NY (US); Paul D. Yacobucci, Rochester, NY (US)

Correspondence Address: Mark G. Bocchetti;Patent Legal Staff, Eastman Kodak Company, 343 State Street, Rochester, NY, 14650-2201, US

(21) Appl. No.: 11/512,903

(22) Filed: Aug. 30, 2006

(51) Int. Cl. B41J 2/01

(52) U.S. Cl. 347/103

(57) ABSTRACT

Printing images on an intermediate member by jetting conductive ink containing a fluid and marking particles in an image-wise fashion onto an intermediate member. The ink is concentrated by application of radio frequency (RF) energy, focused on the ink image to remove a substantial portion of the fluid. The concentrated ink marking particle image, is then transferred to a receiver.

### FIELD OF THE INVENTION

This invention relates generally to ink jet printing and particularly, to printing on an intermediate member so as to concentrate the ink with radio frequency (RF) radiation prior to transfer to paper.

### BACKGROUND OF THE INVENTION

Ink jet technology has become a technology of choice for printing documents and other digitally produced images on receiver members (e.g., paper and other media). In the ink jet process, described in more detail in Inkjet Technology and Product Development Strategies by Stephen F. Pond, Ph. D., and published by Torrey Pines Research in 2000, ink is jetted from an ink jet head that includes one or more ink jet nozzles onto a receiver member.

Contrasting with ink jet technology are other printing technologies such as electrophotography and lithography. Lithography relies on the use of highly viscous inks in which pigment particles are dispersed with relatively small amounts of a fluid such as oil. Typically, the concentration of solids may exceed 90 wt. %. The relatively small amount of solvent present in a lithographic print can be readily absorbed by the receiver member or treated using other suitable methods such as drying by heat, cross-linking, or over-coating with varnish.

Another advantage of the high viscosity inks used in lithography is that the viscosity of the ink limits the ability of the ink to spread. Specifically, ink images often consist of sharp lines of demarcation; such as those that occur with alphanumeric symbols, halftone dots, edges of printed areas, etc. With high viscosity inks, the tendency of the ink to spread is minimized. This allows images on printed pages to have sharp edges and high resolution. It also reduces the tendency of ink to soak into relatively porous receiver members such as those that do not have a coating such as a clay overcoat. Examples of such receiver members include laser bond papers. If low viscosity ink soaks into the paper, paper fibers can show through. This limits the density of the printed image. Yet another advantage obtained with high viscosity inks is the minimization of halftone dot spread. This allows good gray scales to be produced and, for color images, allows images having a wide color gamut to be printed.

Yet another advantage of high viscosity inks such as those used in lithography is that such inks allow images to be printed on glossy papers such as those having a clay coating or polymer overcoat. Low viscosity inks tend to spread or run on these papers, adversely affecting various image quality parameters such as edge sharpness, resolution, and halftone dot integrity, and color balance.

U.S. Pat. No. 5,854,960 discloses a liquid electrophotographic engine having an inking roller, a squeegee to concentrate the liquid ink, and a photoreceptive member. In such apparatus, liquid electrophotographic ink is applied to an inking roller. The ink is then concentrated using the squeegee, preferably a squeegee in the form of a foam roller. This roller absorbs the clear solvent, leaving the marking particles in a concentrated ink. An electrostatic latent image is then formed on the photoreceptor and the latent image developed into a visible image by bringing the latent image bearing photoreceptor into contact with the concentrated ink-bearing inking roller. The marking particles are then electrostatically attracted to the latent image sites on the photoreceptor. It should be noted that, during the ink concentration phase of this process, there is no image information in the ink so that image degradation during the concentration phase cannot occur.

U.S. Pat. No. 6,363,234 discloses a mechanism to concentrate liquid electrophotographic developer including a source of a gas that flows onto a surface containing a liquid developer image and a chamber adjacent to the source and the surface that receives the mixture.

U.S. patent application Ser. No. 11/445,712, filed on Jun. 2, 2006, discloses a digital printing press capable of producing prints at a high speed and high volume that utilizes ink jet technology, rather than an electrophotographic process, for applying the ink. In this type of apparatus, there is no photoreceptive element and there is no electrostatic charge to attract marking particles to specific sites on the primary imaging member. Rather, small ink droplets, often with volumes as little as a few picoliters, are jetted or otherwise deposited strictly where a portion of the image is to be constructed. As discussed in U.S. patent application Ser. No. 11/445,712, filed on Jun. 2, 2006, the aforementioned problems associated with the dilute inks used in ink jet printing apparatus can be eliminated by first imaging by jetting the ink onto a primary imaging member, then concentrating the ink, and then transferring the concentrated ink to the receiver sheet such as paper. Alternatively, the concentrated ink can be transferred to a transfer intermediate member and then transferred from the transfer intermediate member to the receiver member.

Radiational drying of RF active ink jet images directly on the receiver is referred to in U.S. Pat. No. 6,866,378. RF active compositions in general are described in U.S. Pat. No. 6,600,142. The advantages of ink jet imaging via an intermediate are disclosed in U.S. Pat. Nos. 6,682,189 and 6,755,519.

### SUMMARY OF THE INVENTION

Ink jet inks are approximately 90% water and as a result, problems of ink coalescence and paper cockle occur at high printing speeds and at high levels of pictorial coverage as is typically encountered in offset lithography. The present invention overcomes this limitation by printing the ink on an intermediate member upon which the ink can be concentrated to high weight percent solids by the application of radio frequency (RF) radiational energy prior to transfer to paper receiver.

### BRIEF DESCRIPTION OF THE DRAWINGS

In the detailed description of the preferred embodiment of the invention presented below, reference is made to the accompanying drawings, in which:

FIG. 1 is a schematic illustration of an ink jet printing apparatus utilizing RF radiational ink concentration, according to this invention;

FIG. 2 is a plot of the percentage of water removed as a function of binder type, level of solids, and the presence of glycerol or potassium chloride, with an RF exposure time equal to 1.0 seconds; and

FIG. 3 is a plot of the percentage of water removed as a function of binder type, level of solids, and the presence of glycerol or potassium chloride with an RF exposure time equal to 1.5 seconds.

### DETAILED DESCRIPTION OF THE INVENTION

A printed image is formed using an ink having electrically charged marking particles. Although ink such as typical ink jet inks including pigment particles can be used, so long as the other physical requirements of the inks as described herein are met, it is preferable that the ink have polymeric particles. Although clear polymeric particles can be used if desired, it is generally preferable to use polymeric particles including a dye, pigment, or other colorant. In this description, the term “marking particles” shall include said polymeric particles whether or not they have a colorant.

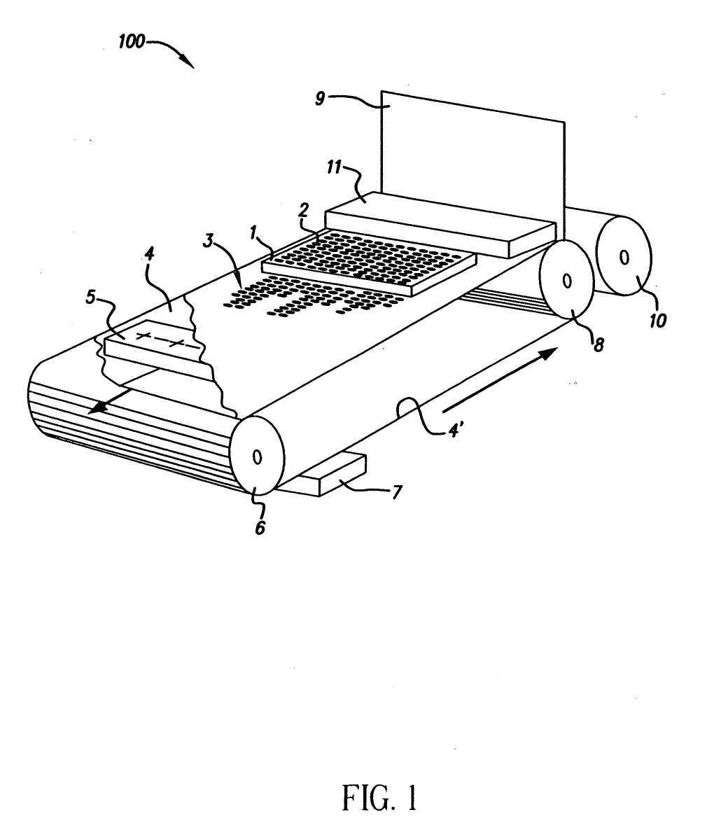

The ink is deposited in an image-wise fashion using appropriate ink jet deposition methods such as a continuous ink jet stream or drop-on-demand technology onto an intermediate. FIG. 1 shows an apparatus 100, which includes an ink jet head 1 comprising rows and columns of ink jet nozzles 2 arranged to deposit fluid droplets in a fluid droplet pattern 3 on a transfer surface 4 of a continuous belt 4′. Pattern 3 is set by the control signals provided to the ink jet nozzles 2 by a controller (not shown in FIG. 1). In this embodiment, the continuous belt 4′ moves in a direction indicated by the arrows. While ink jet nozzles are employed as sources of fluid droplets in preferred embodiments of the invention, the fluid droplet sources may be of other suitable types and the fluid may be an ink jet ink or another ink, a pigment or a resin or any fluid required to create an image or pattern.

Ink jet droplet pattern 3 is subjected to post-deposition processing by radio frequency drying unit 5, the processing changing properties of the ink droplets of pattern 3.

The post-deposition treatment reduces the size of the fluid droplets and changes their rheological properties. For example, the post-deposition treatment may increase a viscosity of the droplets in pattern 3.

In the embodiment of FIG. 1, continuous belt 4′ rolls around rollers 6 and 8. A printing medium 9 is compressed against roller 8 by an elastomeric roller 10. Droplet pattern 3 is transferred from transfer surface 4 of belt 4′ to a surface of medium 9 at the location where medium 9 passes between rollers 8 and 10. Medium 9 may be paper, plastic, polyester, a polymeric material or another material to be printed on or, in general, any substrate to which a fluid-droplet pattern may be transferred. The fluid used to create pattern 3 is chosen to be compatible with medium 9. Medium 9 may be in the form of individual sheets or in the form of a continuous roll. Medium 9 could also be a printed circuit board or a lithographic mask.

In embodiments where the post-deposition treatment includes heating transfer surface 4, should be cooled to a temperature compatible with the type of medium 9 being printed upon before it comes into contact with medium 9. In the embodiment of FIG. 1, this is accomplished by providing transfer surface 4 on an elongated belt 4′ and also by providing a belt-cooling unit 7.

The post-deposition treatment of the droplets of pattern 3 facilitates droplet transfer while preserving dot integrity. Dot integrity is preserved when the shape (i.e. the outline of a dot on the surface of medium 9) is preserved and is consistent from dot to dot. Dots that are deformed from a geometric shape of the nozzles and the transferring surface, or droplets that have coalesced, therefore represent a loss in dot integrity.

Belt 4′ is cleaned by a pre-cleaning unit 11, which removes any remaining ink in preparation for the deposition of more droplets by nozzle array 2. If it is necessary or desirable to control the affinity of the surface of the continuous belt 4′ for the fluid droplets being deposited on it, pre-cleaning unit 11 may clean transfer surface 4 using a liquid hydrophobic cleansing agent, which may be sprayed on or wiped on.

According to this invention, an improved mechanism for ink jet imaging via an intermediate member is provided. Here an ink jet image is concentrated using radio frequency energy, provided by device 5 on an intermediate (belt 4′) prior to transfer to paper. Radio frequency (RF) drying operates over a low range of frequencies such as less than 300 MHz (13.56, 27.12, and 40.68 MHz), compared to microwave drying (915 and 2450 MHz).

Radio frequency concentration -of the ink offers advantages over microwave drying. RF drying is more discriminating toward water and therefore minimizes heating of typical intermediate materials made of plastics or rubbers. Excess heating of the intermediate member materials can lead to distortion of the intermediate member, and this can lead to artifacts such as paper cockle, image smear and/or misregistration, for example, during transfer.

The general principle of RF drying is to expose the ink image sample to an alternating electrical field at appropriate frequency. Polar molecules within the sample respond to the field by rotating. This rotation leads to friction and heating within the sample. If the materials also contain ionic species, these will also move relative to the field. Collisions of these particles with other species lead to collisions and heating. The susceptibility of a material to be polarized by the field is described by the materials dielectric permittivity, ε*. The dielectric permittivity is defined by the following equation:

ε*=ε′−iε″

where ε′ is the dielectric constant and ε″ is the dielectric loss factor.

The power per unit volume absorbed and converted into heat of any material is given by:

W=2πωE ²ε″

where ω is the frequency and E is the electric field strength. The dielectric loss factor is frequency dependent and a function of the moisture and ionic conductivity of the material. The frequency chosen depends on the characteristic of the materials to be dried. For rapid heat-up, conditions are chosen to maximize the dielectric loss factor. For heat sensitive materials, a frequency is chosen to minimize the dielectric loss factor of the dry material. The penetration depth of the energy waves is inversely proportional to frequency.

Referring again to FIG. 1, in a printing apparatus 100, ink is jetted from one or more ink jet print heads 2 to be printed on an intermediate member 4 in an image-wise fashion. Either continuous, thermal drop-on-demand or piezo drop-on-demand, print heads are suitable for use with this invention, and the intermediate member 4 can be a roller or belt. A suitable RF heating device 5 provides radiational energy for heating the ink image for concentration by water removal due to the absorption of radiational energy. Common examples of electrode devices are the parallel plate, stray field, and staggered stray field arrangements. The latter two are typically used for thinner materials such as webs. Thereafter, the concentrated ink image is transferred to a medium 9 by any suitable transfer mechanism associated with roller 10. The transfer mechanism can be a thermal or pressure mechanism or a combination of both.

### Material and Methods

### EXAMPLE 1

To prepare a suitable ink, 85.02 g of a cyan pigment dispersion containing 12.35 wt. % active Pigment Blue 15:3 pigmnent, 0.3 g of biocide Proxel® GXL from Avecia Inc. of Wilmington, Del. (17.0% active), 0.24 g of surfactant EnviroGem® AD01 from Air Products of, 0.9 g of foam suppressant DAPRO® DF 1492 from Elementis Specialties of Hightstown, N.J., and 10.44 g of a polyurethane binder polymer (28.73% active) were added together with distilled water so that the final weight of the ink was 300.0 g. The final ink contained 3.5 wt. % CYAN Pigment. 0.017 wt. % Proxel® GLX, 0.08 wt. % EnviroGem® AD01, 0.3 wt. % DAPRO′ DF 1492, 1.0 wt. % polyurethane binder polymer, and 95.103 wt. % water. The solution was stirred for several hours at 300 RPM using a Lightn™ A310 Axial Flow Impeller from Lightnin of Rochester, N.Y., and then filtered through a 1.0 μm Profile 11 polypropylene filter.

### EXAMPLE 2

A cyan ink was prepared similar to Example 1 except that 170.04 g of the cyan pigment dispersion, and 20.88 g of polyurethane binder was used such that the final ink contained 2.0 wt. % polyurethane polymer and 7.0 wt. % cyan pigment of the total ink. Total solids equaled 11.5 wt. %, with the balance containing water.

### EXAMPLE 3

Example 3 of a suitable ink was prepared similar to Example 1 except that 30.0 g of Glycerol humectant was added such that the final ink contained 10 wt. % glycerol of the total ink.

### EXAMPLES 4-6

Inks for examples 4-6 were prepared similar to Examples 1-3 except the binder used was sulphonated polyester (SP) ionomer Eastman AQ-55® by Eastman Chemical Company of Kingsport, Tenn.

### EXAMPLES 7-9

Inks for Examples 7-9 were prepared similar to Examples 1-3 except the binder used was PLURONIC® L-44 triblock (TB) copolymer binder.

### EXAMPLE 10

Example 10 of a suitable ink was prepared similar to Example 9 except that that 5 g potassium chloride were added such that the final ink contained 5 wt. % potassium chloride of the total ink.

Ink median particle size was measured by light scattering using the Microtrac® UPA150 by Microtrac of Austin, Tex., at 25° C. Ink conductivity was measured with an Orion® Model 550 PH/conductivity meter by Thermo Electron Corporation of Waltham, Mass., at 25° C. Ink static surface tension was measured with a Krüss® digital tensiometer by Krüss GmbH of Hamburg, Germany, at 25° C. Ink viscosity was measured with an Anton Paar® viscometer by Anton Paar GmbH of Graz, Austria at 25° C.

TABLE 1
DRYING EVALUATION

| | | | | | Median | | Static | |
|---|---|---|---|---|---|---|---|---|
| | | % | | | Particle | | Surface | |
| | Binder | Total | % | % | Size | Conductivity | Tension | Viscosity |
| Example | Type | Solids | Water | Glycerol | (microns) | (mS/cm) | (dynes/cm) | (mPa · s) |
| 1 | Polyurethane | 5.95 | 94.05 | 0 | 0.051 | 3.2 | 33.7 | 1.13 |
| | (PU) | | | | | | | |
| 2 | Polyurethane | 11.50 | 88.10 | 0 | 0.039 | 5.9 | 34.1 | 1.35 |
| | (PU) | | | | | | | |
| 3 | Polyurethane | 5.95 | 84.05 | 10 | 0.045 | 2.5 | 33.4 | 1.51 |
| | (PU) | | | | | | | |
| 4 | Sulphonated | 5.95 | 94.05 | 0 | 0.042 | 1.0 | 34.6 | 1.14 |
| | Polyester | | | | | | | |
| | AQ-55 | | | | | | | |
| | (SP) | | | | | | | |
| 5 | Sulphonated | 11.50 | 88.10 | 0 | 0.018 | 1.8 | 35.1 | 1.46 |
| | Polyester | | | | | | | |
| | AQ-55 | | | | | | | |
| | (SP) | | | | | | | |
| 6 | Sulphonated | 5.95 | 84.05 | 10 | 0.045 | 0.8 | 34.0 | 1.50 |
| | Polyester | | | | | | | |
| | AQ-55 | | | | | | | |
| | (SP) | | | | | | | |
| 7 | PLURONIC | 5.95 | 94.05 | 0 | 0.042 | 1.1 | 35.5 | 1.19 |
| | L-44 | | | | | | | |
| | Triblock | | | | | | | |
| | (TB) | | | | | | | |
| 8 | PLURONIC | 11.50 | 88.10 | 0 | 0.022 | 2.0 | 36.2 | 1.54 |
| | L-44 | | | | | | | |
| | Triblock | | | | | | | |
| | (TB) | | | | | | | |
| 9 | PLURONIC | 5.95 | 84.05 | 10 | 0.031 | 0.9 | 35.3 | 1.57 |
| | L-44 | | | | | | | |
| | Triblock | | | | | | | |
| | (TB) | | | | | | | |
| 10 | With | 10.95 | 79.05 | 10 | 0.276 | 63.4 | 30.4 | 4.10 |
| | 5% KCL | | | | | | | |

Prior to concentrating (i.e., drying), the ink was uniformly applied to a polyimide sheet with a wire wound coating rod. With a known coated area and measured increase in weight of the inked substrate, the mass laydown before drying could be calculated. A comparison of the mass laydown after drying to before drying was then used to calculate the percentage of water removed. Typical mass laydowns before drying were 1.9 mg/cm² over a coated area of 10.0×19.0 mm. The RF equipment used for drying was the Macrowave™ heating system from the Radio Frequency Co. of Millis, Mass. This 30 kilowatt unit operated at 40.68±0.05 kHz. The inked substrate was conveyed on a belt. The RF drying circuit consisted of a series of electrodes in contact with the belt (intermediate member 4). The distance from the first to last electrode was 2.44 meters. The web was needed to transport the sample. However, in a printing application, a polyimide belt or other suitable intermediate member would be in direct contact with the electrodes.

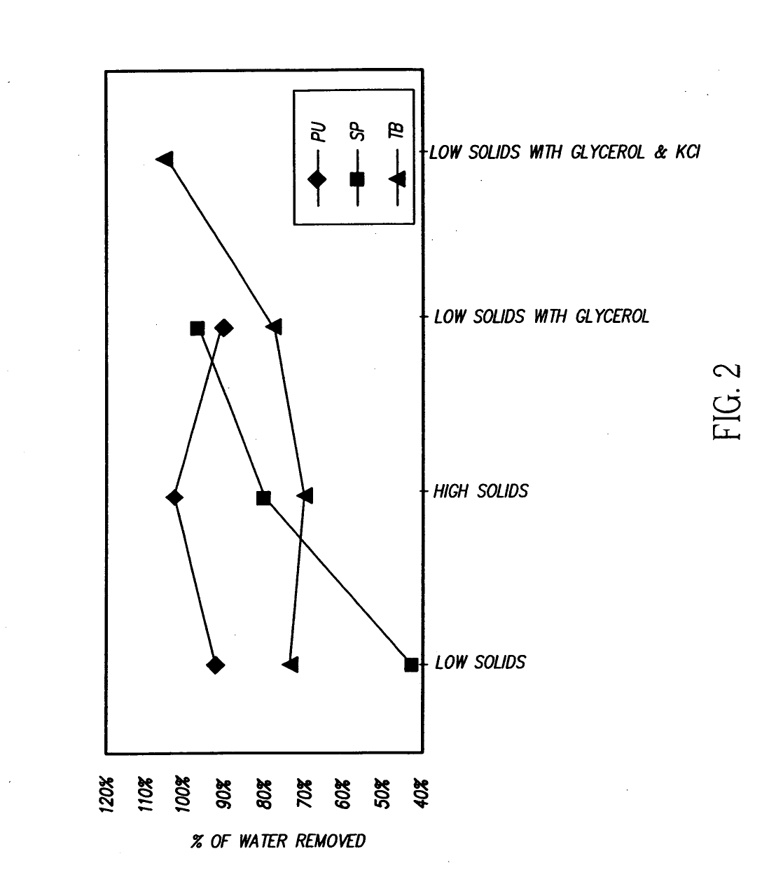

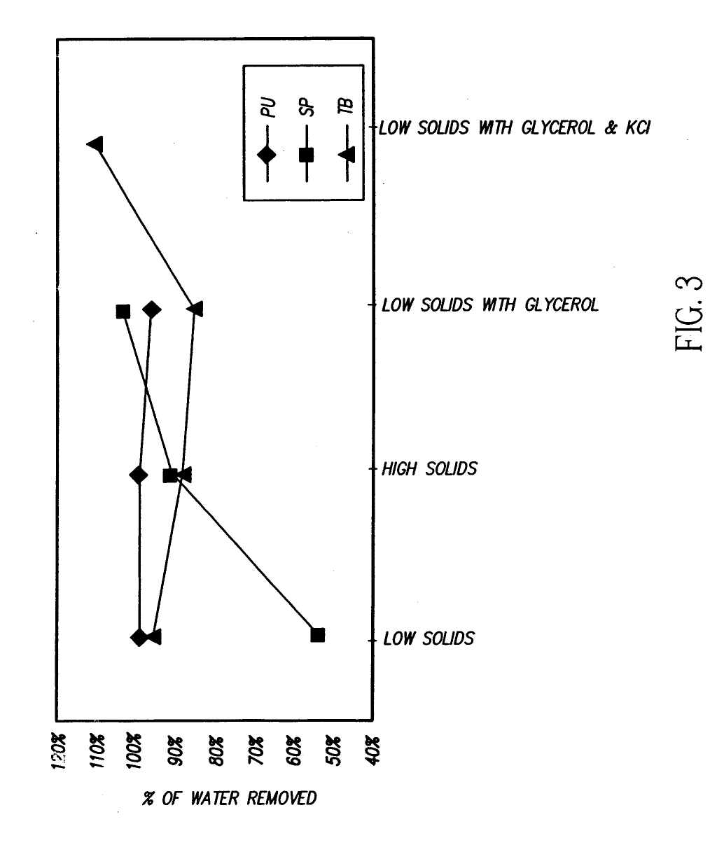

The scaling factor for RF drying is the time the sample is in contact with the RF electrical circuit. Each ink was run under two different RF exposures: 1.0 and 1.5 seconds. Since the total distance of the electrodes is 2.44 meters this corresponds to processing speeds of 2.44 and 1.63 meters/second. The results are listed in Table 2 below and plotted in FIGS. 2 and 3.

The effect of increased exposure is evident by the increase in the percentage of water removed. At either exposure all of the inks were concentrated to a significant degree. The lowest degree of water removal was 43% with several inks reaching 100% removal.

The polyurethane binder has the largest ionic character with 33% of the polymer containing carboxylic groups. These inks had the highest conductivities and RF drying removed the most water. The sulphonated polyester and triblock binders with 9% and 0% ionic character were less active.

The conductivity of the solutions was a strong predictor of water removal and showed that conduction is a significant heating mechanism. This is most evident at the low exposure condition where there is a larger range in the water removal data. The addition of a monovalent salt dramatically increases the conductivity resulting in complete water removal even at low exposure times and triblock binders. Values greater than 100% were achieved at the longer exposure leading to the conclusion that some of the glycerol was volatized under this condition. Monovalent salts have the advantage over divalent or trivalent salts that they can be used to increase conductivity without destabilizing the ink pigment.

The effect of glycerol on water removal was very dependent on the binder polymer used. The most significant effect was seen with the sulphonated polyester binder. The mechanism of this interaction is not clear.

TABLE 2

| Ink | | | | |
|---|---|---|---|---|
| Formulation | Exposure | | | % of Water |
| Examples | (seconds) | Binder | Description | Removed +/− 5% |
| 1 | 1.0 | PU | Low Solids | 93 |
| 2 | 1.0 | PU | High Solids | 103 |
| 3 | 1.0 | PU | Low Solids | 90 |
| | | | With Glycerol | |
| 4 | 1.0 | SP | Low Solids | 43 |
| 5 | 1.0 | SP | High Solids | 80 |
| 6 | 1.0 | SP | Low Solids | 96 |
| | | | With Glycerol | |
| 7 | 1.0 | TB | Low Solids | 73 |
| 8 | 1.0 | TB | High Solids | 70 |
| 9 | 1.0 | TB | Low Solids | 77 |
| | | | With Glycerol | |
| 10 | 1.0 | TB | Low Solids | 104 |
| | | | With Glycerol | |
| | | | And KCl | |
| 1 | 1.5 | PU | Low Solids | 100 |
| 2 | 1.5 | PU | High Solids | 101 |
| 3 | 1.5 | PU | Low Solids | 97 |
| | | | With Glycerol | |
| 4 | 1.5 | SP | Low Solids | 53 |
| 5 | 1.5 | SP | High Solids | 92 |
| 6 | 1.5 | SP | Low Solids | 104 |
| | | | With Glycerol | |
| 7 | 1.5 | TB | Low Solids | 97 |
| 8 | 1.5 | TB | High Solids | 89 |
| 9 | 1.5 | TB | Low Solids | 85 |
| | | | With Glycerol | |
| 10 | 1.5 | TB | Low Solids | 111 |
| | | | With Glycerol | |
| | | | And KCl | |

The invention has been described in detail with particular reference to certain preferred embodiments thereof, but it will be understood that variations and modifications can be effected within the spirit and scope of the invention.

What is claimed is:

1. In an apparatus for printing images on an intermediate member by jetting a conductive ink, containing a fluid and marking particles, in an image-wise fashion onto said intermediate member, a device for concentrating said ink prior to transferring a marking particle image to a receiver member, said ink concentrating device comprising:
a radio frequency (RF) energy supply focused on the ink image to remove a substantial portion of the fluid.

2. The apparatus according to claim 1, wherein said RF energy supply is operative at a frequency in the range of 300 MHz or less.

3. A method for printing images on an intermediate member comprising the steps of:
jetting conductive ink, containing a fluid and marking particles, in an image-wise fashion onto an intermediate member;
concentrating the ink by application of radio frequency (RF) energy, focused on the ink image to remove a substantial portion of the fluid; and
transferring the concentrated ink marking particle image to a receiver.

4. The method of claim 3, wherein RF is operative at a frequency in the range of 300 MHz or less.

5. The method of claim 4, wherein ink conductivity is selected to be at least 0.8 m S/cm.

6. The method of claim 4, wherein ink contains glycerol.
